(19) United States
(12) Patent Application Publication
(10) Pub. No.: US 2015/0302866 A1
(43) Pub. Date: Oct. 22, 2015

(54) SPEECH AFFECT ANALYZING AND TRAINING

(71) Applicant: Tal SOBOL SHIKLER, Lehavim (IL)

(72) Inventor: TALL SOBOL SHIKLER, LEHAVIM (IL)

(21) Appl. No.: 14/435,379

(22) PCT Filed: Oct. 15, 2013
(86) PCT No.: PCT/IL2013/050829

§ 371 Date: Apr. 13, 2015

(30) Foreign Application Priority Data
Oct. 16, 2012 (IL) 222493

(51) Int. Cl. G10L 25/48

(52) U.S. Cl. CPC G10L 25/48

(57) ABSTRACT

We describe a method for the analysis of non-verbal audible expressions in speech, comprising the steps of: providing one or more input means for receiving audible expression from one or more users/participants; transferring said audible expression into speech signal; inputting said speech signal into at least one computer system; processing, at the at least one computer system, said speech signal to determine and output data representing a degree of affective content of said speech signal; and providing a user interface adapted for allowing the analysis of said output data

### FIELD OF THE INVENTION

The present invention relates to the field of speech analysis systems. More particularly, the invention relates to a method and system for speech affect analyzing and training.

### BACKGROUND OF THE INVENTION

Most human communication is non-verbal, where in addition to ideas people express emotions and mental states. Decision making in human-human interactions highly depends on these non-verbal cues, but many people find it difficult to assess them accurately, especially the non-verbal expressions in speech. The need to better assess others' behavior extenuates in remote interactions and in human-machine interactions.

These needs take various forms in different fields and markets. For example, in the education market there is a strong link between emotions, motivation and cognition. One emerging need is for teachers in remote education to be able to assess students' emotional state (uncertainty, anxiety, interest level, etc) and change the tutoring strategy accordingly. Other markets in which there are specific needs for such analysis, include: business (face-to-face and remote), in negotiations, interviews, marketing, sales and costumer retainment; security, intelligence, army and emergency forces, for assessing both enemies' intentions and people's well-being; diagnosis support; therapeutic and paramedical treatments; assistive technology; games, human-robot, human-machine & human-smart environment interactions, and more. In addition, most people feel uncomfortable speaking in public and need training. Feedback for training is beneficial to various disciplines in which people have to speak in an effective manner, from students, through teachers to sales personnel, negotiators and politicians. Background prior art can be found in U.S. Pat. No. 8,249,875 and in U.S. Pat. No. 8,036,899.

A method of processing a speech signal to determine a degree of affective content comprises: inputting said speech signal; analyzing said speech signal to identify a fundamental frequency of said speech signal and frequencies with a relative high energy within said speech signal; processing said fundamental frequency and said frequencies with a relative high energy to determine a degree of musical harmonic content within said speech signal; and using said degree of musical harmonic content to determine and output data representing a degree of affective content of said speech signal.

Preferably the musical harmonic content comprises a measure of one or more of a degree of musical consonance, a degree of dissonance, and a degree of sub-harmonic content of the speech signal. Thus in embodiments a measure is obtained of the level of content, for example energy, of other frequencies in the speech signal with a relative high energy in the ratio n/m to the fundamental frequency where n and m are integers, preferably less than 10 (so that the other consonant frequencies can be either higher or lower than the fundamental frequency).

In one embodiment of the method the fundamental frequency is extracted together with other candidate fundamental frequencies, these being frequencies which have relatively high values, for example over a threshold (absolute or proportional) in an autocorrelation calculation. The candidate fundamental frequencies not actually selected as the fundamental frequency may be examined to determine whether they can be classed as harmonic or sub-harmonics of the selected fundamental frequency. In this way a degree of musical consonance of a portion of the speech signal may be determined. In general the candidate fundamental frequencies will have weights and these may be used to apply a level of significance to the measure of consonance/dissonance from a frequency.

The skilled person will understand the degree of musical harmonic content within the speech signal will change over time. In embodiments of the method the speech signal is segmented into voiced (and unvoiced) frames and a count is performed of the number of times that consonance (or dissonance) occurs, for example as a percentage of the total number of voiced frames. The ratio of a relative high energy frequency in the speech signal to the fundamental frequency will not in general be an exact integer ratio and a degree of tolerance is therefore preferably applied. Additionally or alternatively a degree of closeness or distance from a consonant (or dissonant) ratio may be employed to provide a metric of a harmonic content.

Other metrics may also be employed including direct measurements of the frequencies of the energy peaks, a determination of the relative energy invested in the energy peaks, by comparing a peak value with low average value of energy, (musical) tempo related metrics such as the relative duration of a segment of speech about an energy peak having pitch as compared with an adjacent or average duration of silence or unvoiced speech or as compared with an average duration of voiced speech portions. As previously mentioned, in some preferred embodiments one or more harmonic content metrics are constructed by counting frames with consonance and/or dissonance and/or sub-harmonics in the speech signal.

Some basic physical metrics or features which may be extracted from the speech signal include the fundamental frequency (pitch/intonation), energy or intensity of the signal, durations of different speech parts, speech rate, and spectral content, for example for voice quality assessment. However in embodiments a further layer of analysis may be performed, for example processing local patterns and/or statistical characteristics of an utterance. Local patterns that may be analyzed thus include parameters such as fundamental frequency (f.sub.0) contours and energy patterns, local characteristics of spectral content and voice quality along an utterance, and temporal characteristics such as the durations of speech parts such as silence (or noise) voiced and un-voiced speech. Optionally analysis may also be performed at the utterance level where, for example, local patterns with global statistics and inputs from analysis of previous utterances may contribute to the analysis and/or synthesis of an utterance. Still further optionally connectivity among expressions including gradual transitions among expressions and among utterances may be analyzed and/or synthesized. The analysis does not require speech coherence or intelligibility, so it may be applied to people who speak with various accents, or with various speech disorders, such as post-stroke, hard-of-hearing, young children, and more.

One or more of the above metrics may be combined to provide a numeric, verbal, symbolic, graphical or another human perceptible or machine processable representation of the affective content of the analyzed speech. The combinations of metrics and links to affective output, more particularly a graphical representation of affective output, may be determined, for example, by determining a set of parameters linking the metric(s) to each of a set of affect features such as anxiety, stress, confidence and the like, as previously mentioned. The values of these parameters may be determined, for example, from a corpus (or corpuses) of previously labeled speech signals (they may, for example, have been categorized by human listeners). This may be used to provide a training data set. The skilled person will recognize that there are many ways of doing this including, but not limited to: principal component analysis, non-negative matrix factorization, support vector machines, neural networks, decision trees, hidden Markov models, methods for detection of a single class, methods for determining one of multiple classes, methods of multi-class and multi label classification, methods for detection of large data and a large number of options, voting procedures, combinations of such methods, and the like.

It is an object of the present invention to enable people to objectively visualize the affective (emotional and mental) states important to them, in themselves (for training) and in others (analysis), on-site or remote, in real-time or from recordings.

It is another object of the present invention to add multi-modal analysis; further the decision making support; allow technology appliances, such as: computer games, robots, wearable, and smart environments, to better respond to their users' needs, by being able to analyze them; (being able to edit and synthesize enriched responds is in the previous patent).

Other objects and advantages of the invention will become apparent as the description proceeds.

### SUMMARY OF THE INVENTION

The present invention relates to a method for the analysis of non-verbal audible expressions in speech, comprising the steps of:
a. providing one or more input means for receiving audible expression from one or more users/participants;
b. transferring said audible expression into speech signal;
c. inputting said speech signal into at least one computer system;
d. processing, at the at least one computer system, said speech signal to determine and output data representing (a degree of) affective content of said speech signal; and
e. providing a user interface adapted for allowing the analysis of said output data.

According to an embodiment of the present invention, the method further comprises allowing storing in a database related to the computer system the speech signal and/or the degree of affective content of said speech signal.

According to an embodiment of the present invention, the user interface allows analyzing both pre-recorded speech signals and real-time speech signals. The user interface allows the comparison (manual, automatic, or both) between speech signals acquired on various occasions, such as pre-recorded signals and real-time signals, and the like.

According to an embodiment of the present invention, the method further comprises providing the selection of affective states to the users, or a set number of affective states.

According to an embodiment of the present invention, the method further comprises providing selection of visualization formats to the user.

According to an embodiment of the present invention, the method further comprises various settings of input formats and output formats may be available to the users: Various inputs of sound and/or video recordings, various presentations of the results (e.g., colors, size, time scales of the analysis, types of analysis, etc).

According to an embodiment of the present invention, the method further comprises generating summaries of the analysis either automatically or semi-automatically, with/without details of the analyzed interaction/interactions. The summaries could be in an editable and/or printable format. The summaries could be in a computerized form, with ability of the user to pin-point a time of interest in the analysis, and hear or see the relevant recorded signal. Pin-pointing and replaying would be allowed also from the main application, not only from the summaries.

According to an embodiment of the present invention, the analysis could be of the expressions of several users (or other speakers/participants/people defined by the user/s) at the same time. For example, this can be done by showing the different participants in various forms. The various forms are selected from the group consisting of video, icons, images, name tags, text or any combination thereof. The method further comprises showing analysis of one or several participant, with various degrees of complexity and detail.

According to an embodiment of the present invention, the method further comprises allowing presentation of images, speech signal, various vocal features, analysis of one or of several utterances or sentences, analysis of an entire interaction and of several interactions, various pinpointing and highlighting options in any applicable form such as in graphics, video, sound, speech, text, text-to-speech, electronic formats, numbers, images, synthesized facial and body expressions, colors, shape and motions of avatars or robots, and more.

According to an embodiment of the present invention, the method further comprises allowing integrating with one or more modalities or cues.

According to an embodiment of the present invention, the analysis further comprises one or more levels of expression of each chosen affective state.

According to an embodiment of the present invention, the person recording, or the person analyzing, or the analysis system could also time stamp places of interest, to appear in the various visualization and report manners.

According to an embodiment of the present invention, the method may further comprise automatically segmenting or parsing a speech signal into sentences or utterances, present them, write them as separate files, perform the analysis on them, write a file that represent them and their respective analysis, point to them (or to the main file) when a certain area of the analysis or of the signal is chosen (such as pointed, highlighted, referred to by speech, etc.) by the user. The method may further comprise providing editing capabilities of the speech signal and division into sentences and utterances for analysis. Optionally, parallel analysis may be presented of the various cues, in various formats, including markings of complimenting, enhancing or contradicting analysis results. The analysis may be accompanied by additional advice for better decision making, by graphical and/or vocal advice for training, and the like.

According to an embodiment of the present invention, the user is a human or a computerized entity, such as a computer game, a car or a robot.

In embodiments of the above described method the affective content may include the dynamics of affective content. Optionally the method may further comprise providing analysis of additional types of data, such as physiological and behavioral cues, metadata, text, sensor, analysis of large groups' behavior, and more. Optionally the method may further comprise providing either combined analysis of these data, and or an interface which presents or utilizes the data or part of it, and/or the analysis results.

In embodiments the user interface is arranged to provide a graphical indication of a score within a range, for example a bar chart-type display, the score representing each of a plurality of affect features of said speech signal. The affect features may comprise at least two, three or more affect features selected from: anxiety, unsure, concentrating, confident, sure, interested, motivated, focused, disagree, stressed, amused, happy, angry, annoyed, worry, excited, thinking, uncertain, hesitates, agree, tired, depressed.

In embodiments the user interface is configured to provide such a graphical indication for a plurality of users simultaneously, to permit comparison between the users. The users may be, for example, pupils of a teacher, or call centre clients, or call centre operators.

Additionally or alternatively the user interface may be configured to provide such a graphical indication for a time series of instances of the speech signal, such as distinguishable utterances, sentences, or answers to questions, to permit comparison between the time series of instances of said speech signal.

In a related aspect the invention provides a method for the analysis of affective states (emotional, cognitive and mental states) comprising the steps of: capturing speech and optionally other data into a computer wherein the data provides information for evaluating the affective state of the individual; providing one or more input means for receiving said data from at least one individual; inputting said data into at least one computer system; processing, at the at least one computer system, said speech signal to determine and output data representing a degree of affective content of said speech signal; and providing a user interface adapted for allowing the analysis of said output data. Optionally the method may process other data to infer affective state, and or other relevant information for the analysis of the individual behavior, in relation to the speech analysis or without it; and then preferably generate an output comprising a humanly perceptible stimulus or machine processable stimulus indicative of said at least one mental state. Optionally the method may present other captured and or processed data. Optionally the method may provide decision-making support based on the analysis results, and the context of its application.

In embodiments the data includes past and present of audio and speech, and optionally other information related to the individual, for example including one or more of: comprising body movements, facial expressions, physiological information, verbal content of speech, action and decisions of the individual, their results, events, behavior of other individuals, contextual parameters, metadata, written text, previous recordings of all these data types, recordings and or analysis results of others, and potentially more. The physiological information may include one or more of electrodermal activity, heart rate, heart rate variability, skin coloration, iris size and direction, proximity, acceleration, and others. The speech may include the verbal and non-verbal content of speech and/or other sounds and vocalizations generated by the individual. The capturing and the analysis may be done for face-to-face, person-to-machine, remotely, through various communication means, and/or otherwise.

In embodiments at least one affective state is inferred, or co-occurring affective states, in particular their level or degree, nuances of appearance, and/or their dynamics are analyzed and presented. The determination of affective contents, their respective analysis, presentations, and system responses may relate to various time spans and temporal characteristics. The determination of affective contents may relate to either a base-line behavior determined by either the individual's previous behavior, at a certain point in time, or during a certain period of time; a base-line accumulated from behaviors of several or many people; a base-line determined arbitrarily or according to other inference techniques, and/or an on-going process of learning, adaptation and adjustment. Various analysis techniques may be used for deriving the affective content, such as multi-class and multi-label classification, dynamic and time-varying methods, through combinations of other affective states, combination of cues and data, and more. Optionally the analysis information includes correlation for the affective state of other people to the data which was captured on the affective state of the individual. The correlation may be based on metadata from the individual and metadata from the plurality of other people.

The embodiment of the user interface may also encompass indicatives of a very large set of affective states or features. This wider selection can be derived directly from the vocal features, and/or the other data types, and/or in several stages, in which the degrees of one, or several affective states or groups of plurality of affective states, such as the groups of afraid, angry, bored, bothered, disbelieve, disgusted, excited, fond, happy, hurt, interested, concentrates, kind, liked, romantic, sad, sneaky, sorry, sure, surprised, thinking, touched, unfriendly, unsure, and/or wanting, or descriptive groups such as positive/negative, active/passive, each comprising multiple affective states, the groups are not mutually exclusive, are recognized first, and their combinations then provide indications on the degrees of a wider set of (hundreds of) affective states, i.e. most or the entire set of lexical definitions that can be described as affective states, some of these methods are described in T. Sobol-Shikler, ‘Automatic Inference of Complex Affective States’, Computer, Speech and Language, vol. 25, pp. 45-62, 2011. Thus the embodiment of the user interface may comprise of a very wide set of emotions, cognitive states, social etiquette, intentions, moods, personality traits, physiological states (such as fatigue, stress), mental states, and mental disorders and diseases. The user interface may encompass of a single affective feature, and/or a closed set of affective features, and/or of a wide set of affective states and features.

In embodiments of the method the affect features comprise a very large set of affective features, as defined by dictionaries and lexical guides, and which can be detected by the system. One, a few, or many of these affective states may, either be selected by the user or pre-defined according to the area of application. These selected affective features may be highlighted upon detection, with or without indications of temporal relevance.

Each affective state or affect feature may represent one and/or a group of related affective states with close or related meanings (for example, a partial group may consist of the affective states stress, anxiety, tension, worry, and more) and/or affective states whose expressions and meanings are the combinations of individual states and/or combinations of groups of affective states. A group of affective states may be referred to in any name including a name which belongs to one of its components. The affective features and states may refer, among others, to personality traits, moods, intentions, cognitive, emotional, psychiatric, physiological and medical states.

In another aspect the invention relates to a system for the analysis of non-verbal audible expressions in speech, comprising:
a. one or more input means for receiving audible expression from one or more users/participants;
b. at least one computer system provided with an affect editor engine for processing the digital representation of said audible expression in order to determine and output data representing a degree of affective content of said speech signal; and
c. a user interface adapted for allowing the interaction and the analysis of said output data.

In embodiments the system may include one or more systems/software or other means for implementing the previously described features of the methods according to aspects/embodiments of the invention. These features will not be repeated here, for conciseness.

The method/system may be embodied in software. Thus the invention further provides processor control code to implement the above-described systems and methods, for example on a general purpose computer system or on a digital signal processor (DSP). The code is provided on a physical data carrier such as a disk, CD- or DVD-ROM, programmed memory such as non-volatile memory (e.g. Flash) or read-only memory (Firmware). Code (and/or data) to implement embodiments of the invention may comprise source, object or executable code in a conventional programming language (interpreted or compiled) such as C, or assembly code, or code for a hardware description language. As the skilled person will appreciate such code and/or data may be distributed between a plurality of coupled components in communication with one another.

### BRIEF DESCRIPTION OF THE DRAWINGS

In the drawings:

FIG. 1 shows a schematic diagram of an affect editing system, which may be implemented on a various computerized systems, appliances and apparatus;

FIGS. 2-8 are example of screen layout for variety of application that based on the affect editing system, according to some embodiments of the present invention.

### DETAILED DESCRIPTION OF THE INVENTION

Throughout this description the term “affective states” refers to emotions, mental states, attitudes, beliefs, intents, desires, pretending, knowledge, moods and the like. Their expressions reveal additional information regarding the identity, personality, psychological and physiological state of the speaker, in addition to context related cues and cultural display rules. This wide definition of the term affective states draws on a comprehensive approach to the role and origin of emotions: affective states and their expressions are part of social behavior, with relation to physiological and brain processes. They comprise both conscious and unconscious reactions, and have cause and effect relations with cognitive processes such as decision making. A number of affective states can occur simultaneously, and change dynamically over time. The affective state is a well-known term described, for instance in “Classification of complex information: Inference of co-occurring affective states from their expressions in speech” by Tal Sobol Shikler et. al., IEEE Transactions on Pattern Analysis and Machine Intelligence, Volume 32 Issue 7, July 2010, Pages 1284-1297.

The term “expression” refers here to the outward representation of affective states. This is the observable behavior (conscious or unconscious) that people can perceive and would like to interpret. It can be affected by factors such as context and cultural display rules. This perspective is also reflected in automatic synthesis systems that aim to imitate only the behavioral expressions and not their source (automatic systems do not feel nor think at this stage).

Throughout this description the term “speech signal” refers either to a single signal or plurality of signals.

Affective states and their behavioral expressions, and in particular their non-verbal expressions in speech, are important aspects of human reasoning, decision-making and communication. According to the ‘Theory of mind’ (D. Premack and G. Woodruff, “Does the chimpanzee have a ‘theory of mind’?”, Behavior and Brain Sciences, vol. 4, pp. 515-526, 1978, and S. Baron-Cohen, A. Leslie, and U. Frith, “Does the autistic child have a theory of mind?” Cognition, vol. 21, pp. 37-46, 1985.), affective states such as beliefs, intents, desires, pretending and knowledge, can be the cause of behavior and thus can be used to explain and predict others' behavior. Visualization of these cues can enhance human-human communication, enhance the understanding of others and hence support decision making in interactions with others in various situations, and can be used to improve communication skills. The integration of affective states and their behavioral correlates in fields such as human computer interfaces and interactions (HCI), human-robot interactions (HRI) and speech technologies can enhance the system and user performance as described in greater details hereinafter with respect to HCI and HRI applications. Therefore, there is an increased interest in detecting, analyzing and imitating these cues.

Reference will now be made to several embodiments of the present invention(s), examples of which are illustrated in the accompanying figures. Wherever practicable similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles of the invention described herein.

Unless otherwise indicated, the applications and their functions described herein may be performed by executable code and instructions stored in computer readable medium and running on one or more processor-based systems. However, state machines, and/or hardwired electronic circuits can also be utilized. Further, with respect to the example processes described herein, not all the process states need to be reached, nor do the states have to be performed in the illustrated order. Further, certain process states that are illustrated as being serially performed can be performed in parallel.

Similarly, while certain examples may refer to a workstation such as a computer system, other computer or data systems can be used as well, such as, without limitation, a Personal Computer (PC), a tablet, an interactive television, a network-enabled personal digital assistant (PDA), a network game console, a networked entertainment device, a smart phone (e.g., with an operating system and on which a user can install applications) and so on. For example, the application(s) could be active on various computerized systems, such as PCs, client & server, cloud, mobile devices, robots, smart environments, game platforms and the like.

The terms, “for example”, “e.g.”, “optionally”, as used herein, are intended to be used to introduce non-limiting examples. While certain references are made to certain example system components or services, other components and services can be used as well and/or the example components can be combined into fewer components and/or divided into further components.

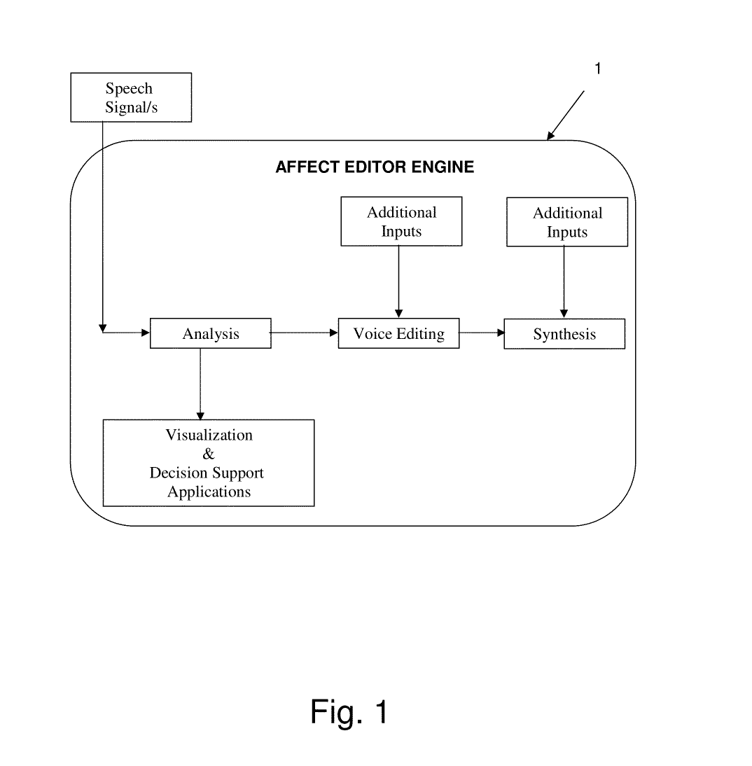

FIG. 1 shows an affect editor engine that can be used in conjunction with the invention. The affect editor engine illustrated in this figure is particularly convenient because it can be applied as an add-on module to existing systems without the need to carry out major alterations. For example, the affect editor engine generally indicated by numeral 1 in the figure may comprise elements similar to the affect editor disclosed in U.S. Pat. No. 8,036,899, such as input means to receive speech analysis data from a speech analysis system, said speech analysis data comprising a set of parameters representing said speech signal; a user input to receive user input data defining one or more affect-related operations to be performed on said speech signal; an affect modification system coupled to said user input and to said speech processing system to modify said parameters in accordance with said one or more affect-related operations and further comprising a speech reconstruction system to reconstruct an affect modified speech signal from said modified parameters; and an output coupled to said affect modification system to output said affect modified speech signal; wherein said user input is configured to enable a user to define an emotional content of said modified speech signal, wherein said parameters include at least one metric of a degree of harmonic content of said speech signal, and wherein said affect related operations include an operation to modify said degree of harmonic content in accordance with said defined emotional content.

The affect editor engine, shown schematically in FIG. 1, takes an input speech signal X, and allows the user to modify its conveyed expression, in order to produce an output signal \tilde{X}, with a new expression. The expression can be an emotion, mental state or attitude. The modification can be a nuance, or might be a radical change. The operators that affect the modifications are set by the user. The editing operators may be derived in advance by analysis of an affective speech corpus. They can include a corpus of pattern samples for concatenation, or target samples for morphing. A complete system may allow a user to choose either a desired target expression that will be automatically translated into operators, features, metrics and contours, or to choose the operators and manipulations manually. The editing tool preferably offers a variety of editing operators, such as changing the intonation, speech rate, the energy in different frequency bands and time frames, or the addition of special effects.

Using this affect editor engine may also employ an expressive inference system and corresponding applications that can supply operations and transformations between expressions and the related operators. Another preferable feature is a graphical user interface that allows navigation among expressions and gradual transformations in time.

According to an embodiment of the present invention, the affect editor engine is a tool that can be used in a speech affect analyzing and training system. Such a system encompasses various editing techniques for expressions in speech. It can be used for both natural and synthesized speech. According to an embodiment of the present invention, the system is adapted to perform debate analysis between two or more candidates, as it uses a natural expression in one utterance by a particular speaker for other utterances by the same speaker or by other speakers. Natural new expressions may be created without affecting the voice quality.

The speech affect analyzing and training system of the present invention, may also employ an expressive inference system that can supply operators and transformations between expressions and the related operators. Another preferable feature is a graphical user interface that allows navigation among expressions and gradual transformations in time. Various presentations of the analysis results may be used. Interactive presentations of the analysis may be integrated.

The speech affect analyzing and training employs a preprocessing stage before editing an utterance. In preferred embodiments post-processing is also necessary for reproducing a new speech signal. The input signal is preprocessed in a way that allows processing of different features separately. For example, such applicable pre-processing stages are disclosed in U.S. Pat. No. 8,036,899.

According to an embodiment of the present invention, the affect analyzing, training, and presentation may integrate multiple modalities and cues in addition to speech, such as speaker recognition, speech recognition, facial expression analysis, head movement, posture, hand gestures and body gestures, and physiological cues, such as heart rate and heart rate variability, skin conductivity, skin coloring, iris direction and size, text and metadata on the individual, input from sensors, input concerning the context of the analysis, and more.

In the case of multi-modal analysis, indicators that show the relations between the individual cues, such as complementing, enhancing, supporting, or contradicting, etc.

As will be appreciated by the skilled person the arrangement described in the figure results in a speech affect analyzing and training system that can be adapted for various type of private, corporate, academic and governmental application, for example: intelligence, security, army, emergency, negotiators, interrogators, interviews, sales (e.g., attract and retain customers), diagnosis support (e.g., stress, fatigue, mental disorders, Autism spectrum disorders, etc.), assistive tech (e.g., hard of hearing, autism, etc.), therapeutic & paramedical applications, games, HCI, HRI, research, smart environments, training and feedback, remote and on-line (e.g., learning, commerce, etc), analysis of social tendencies, group analysis, on various media (broadcast, face-to-face, web, social networks, etc), and more. The analyzing and training system can also include decision-making support algorithms and various forms of resulting actions (if integrated in larger systems such as robots) and/or suggestions for the user.

All the above will be better understood through the following illustrative and non-limitative examples. The example screen layouts, appearance, and terminology as depicted and described herein, are intended to be illustrative and exemplary, and in no way limit the scope of the invention as claimed.

### Example 1

### Teacher-Student Oriented System

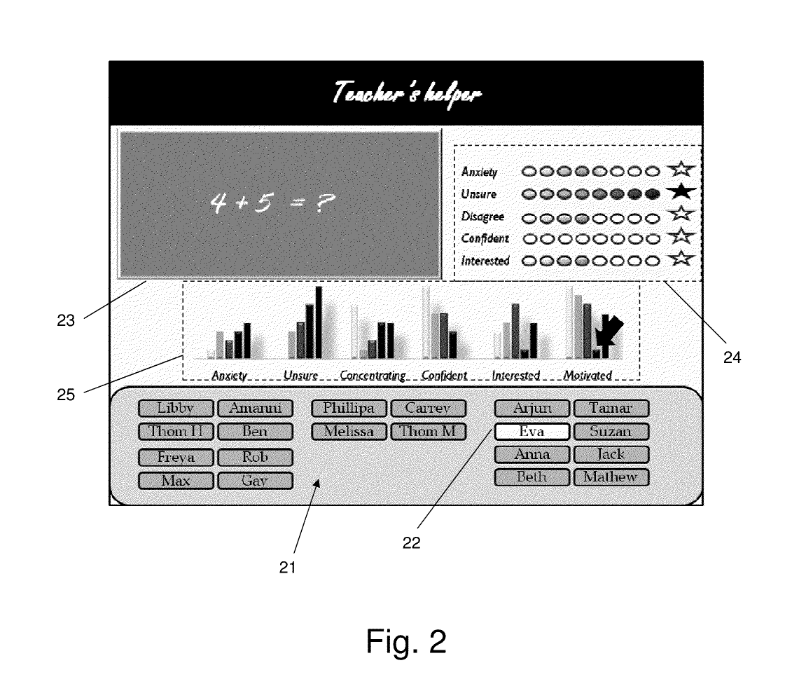

The system of the present invention can be implemented as a teacher's helper system. For example, as shown in FIG. 2, the system allows showing analysis of plurality of students in parallel, with various degrees of complexity and details. The system allows the presentation of the participant students (e.g., by images and/or textual form as shown in the area indicated by numeral 21), and accordingly the specific parameters related to each student (e.g., speech signal, various vocal features, analysis of one or of several utterances or sentences, analysis of an entire interaction and of several interactions, various pinpointing and highlighting options) in any applicable format such as graphics, animation, video, sound, speech, text, text-to-speech, electronic formats, numbers, and more. In this example, the parameters regarding the student named “Eva” are shown. The currently active student name (e.g., Eva) is highlighted (as indicated by numeral 22), and the corresponding affective states and expression are shown (as indicated by numeral 24 and 25) with respect to a specific presented subject (e.g., an answer required to a specific mathematical expression (e.g., as indicated by numeral 23).

According to an embodiment of the invention, there possible presentation forms of the analysis as a color-coded time-line, in which certain colors are given to high intensity of expression (for example, shades of orange-to-dark red for high and increasing intensity, and shades of cyan-to-dark blue for low and decreasing intensities). Moreover, various highlighting techniques can be used to point extreme values, values of interests, periods of interest in the analysis, by the software (e.g., as indicated by values in graphical representation indicated by numerals 24 and 25 in FIG. 2). A summary of the interaction can be generated, in an editable format and/or in an interactive format, in which reference can be made to periods/sentence/utterances of interest, which can be re-played. Times of interest can also be marked during the recording. The analysis can be done per-person and/or per a group of people/students.

### Example 2

### Call/Sales/Service/Marketing Center

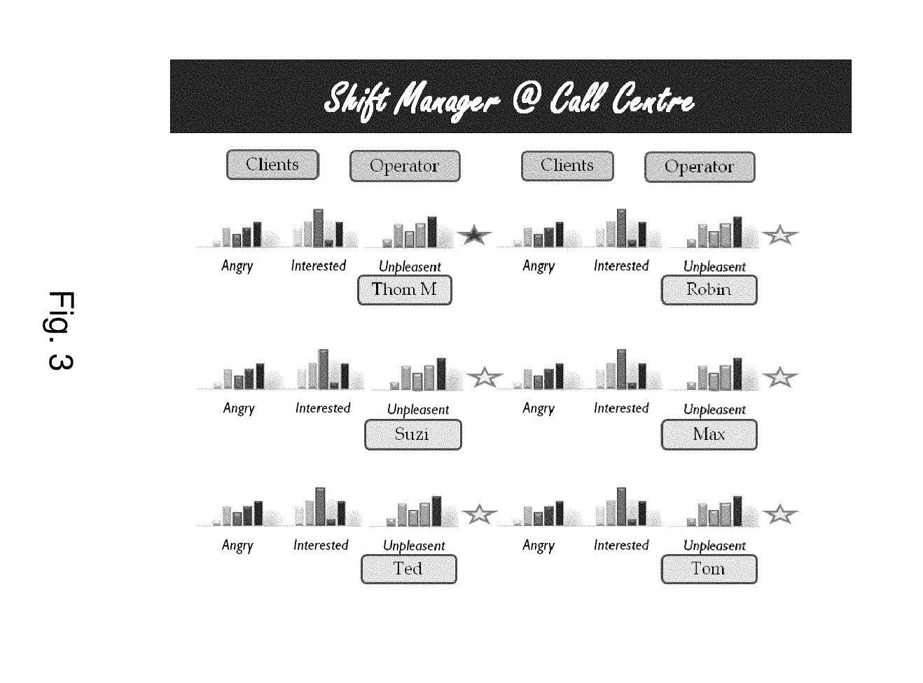

FIG. 3 schematically illustrates an exemplary layout that represents the implementation of the system as a call center, according to an embodiment of the present invention. In this example, the system summaries the affective states and expression (e.g., according to variety of parameters, such as angry, interested, unpleasant, etc.) as obtained for the entire clients (e.g., on daily, weekly, or monthly base) of each specific operator. Such a system can be used to detect weakness of each operator, and may also be used to train that operator to improve his speech performance, and to solve communication problems. Alternatively this can be used to detect and follow the mental state of individuals within various types of groups, for tracking required mental states, or to explore their interaction atmosphere.

The system allows the objective visualization of various levels of expression of several affective states for each sentence or utterance, and tracking of tendencies and changes in these expression levels over time. Currently, the technology was tested with plurality of affective states, including emotions, mental states, attitudes, and other manners of human expressions, these can be changed to suite each specific application and the needs of the clients.

### Example 3

### Interviews, Negotiations, Sales and Customer Service

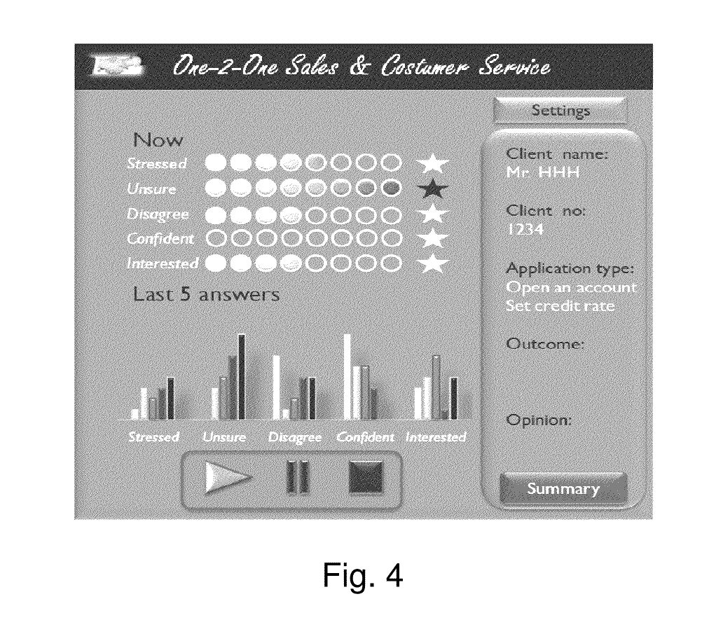

FIG. 4 schematically illustrates an exemplary layout that represents the implementation of the system as a sales/customer service, according to an embodiment of the present invention. In this embodiment, the system enables visualization of the current or recent state of events; tracking progression of chosen affect levels over time and highlight important events during an interaction and between interactions. In this figure, the system shows the user (e.g., a salesman) the level of the client according the last 5 answers of that client, e.g., whether the client is stressed, unsure, disagree, confident or interested. This can be applied to face-to-face interactions, and to remote interactions. The system may issue an analysis report, automatically, or prompted by the user. This can be used to decide which marketing, negotiation, medical diagnosis, or costumer retainment strategies to apply, and the like. It can be used by emergency call-centers and forces, human-resource personnel, for interviews and negotiations, and more.

According to an embodiment of the present invention, the system may automatically segment or parse a speech signal into sentences or utterances, present them, write them as separate files, perform the analysis on them, write a file that represent them and their respective analysis, point to them (or to the main file) when a certain area of the analysis or of the signal is chosen (such as pointed, highlighted, referred to by speech, etc.) by the user. Furthermore, the system may generate summaries of the analysis either automatically or semi-automatically, with/without details of the analyzed interaction/interactions. Moreover, the system may provide time stamp places of interest, to appear in the various visualization and report manners.

### Example 4

### Person Recording

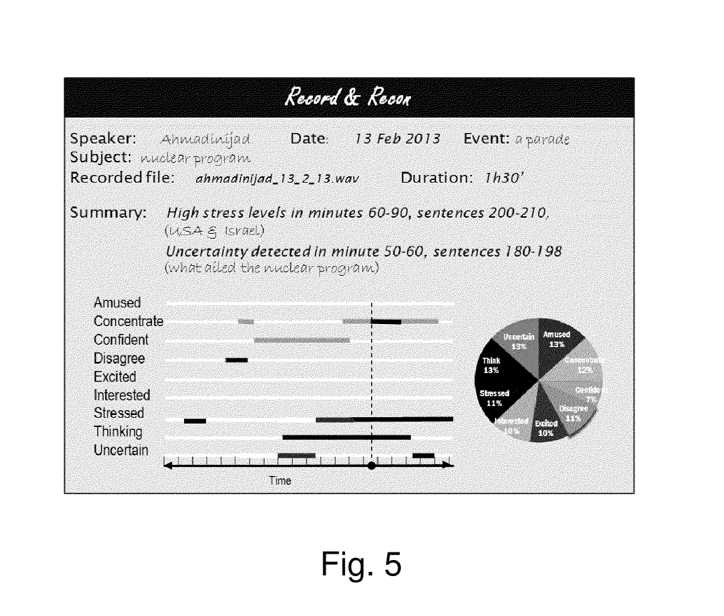

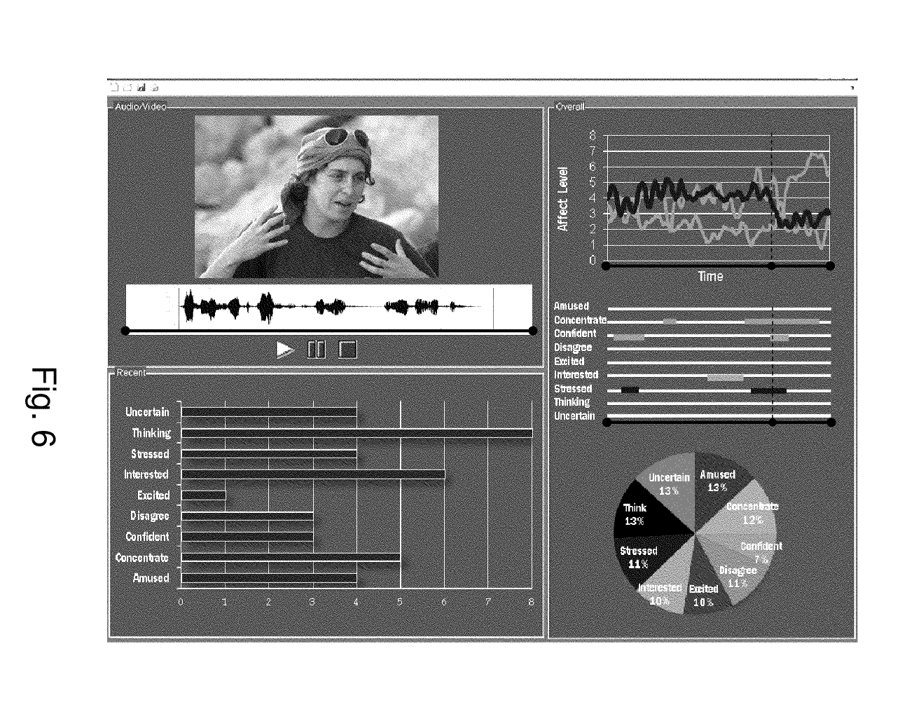

FIG. 5 schematically illustrates a graphical representation of a person recording, according to an embodiment of the present invention. In this example, after a 1:30 hours of total speech recording, the system summaries the affective states and expression of the speaker and indicates that high stress level were detected in minutes 60-90 in sentences 210-210, and uncertainly detected in minutes 50-60 in sentences 180-198. Accordingly, the content of the speech within this time stamps can be examined either by the person itself or by other user. FIG. 6 schematically illustrates another form of a graphical representation of a speaker including a video stream.

### Example 5

### Interview

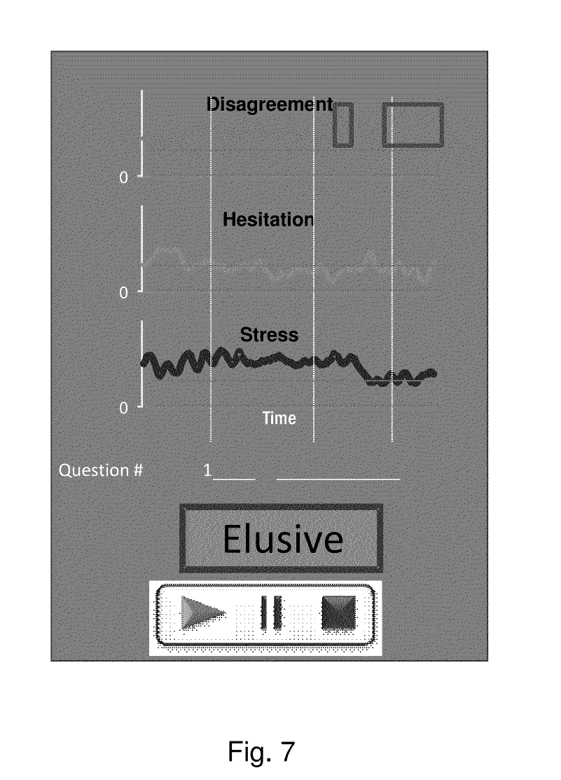

FIG. 7. schematically illustrates a graphical representation of a person recording, according to an embodiment of the present invention. In this example, one can see transitions and tendencies of certain affective states, chosen for the specific context, of an individual over time, along with the time of points of interest or events, such as questions asked, automatic highlighting of remarkable values or value transitions (clear rectangles), highlighting in real-time significant more temporary behavior (the rectangle marked “Elusive”), which was not necessarily pre-specified by the user, which signifies more complex meanings, and whose appearance recedes in time. All these allow the user to keep the focus on the speaker, while providing clear and significant input. Post interview, the data can be gathered automatically, semi-automatically or manually, into reports and editable documents. “Elusive” here signifies a second processing of the affective states, done through combinations of groups of affective states, via statistical processes and two voting procedures. In case of an automated system using the analysis, the time stamps, the significant values, and the significant affective states, can be automatically processed.

### Example 6

### Graphical User Interface, and/or a Game, and/or Smart Environments, Such as Home, Car, Robots, Hospital, Mall, and the Like

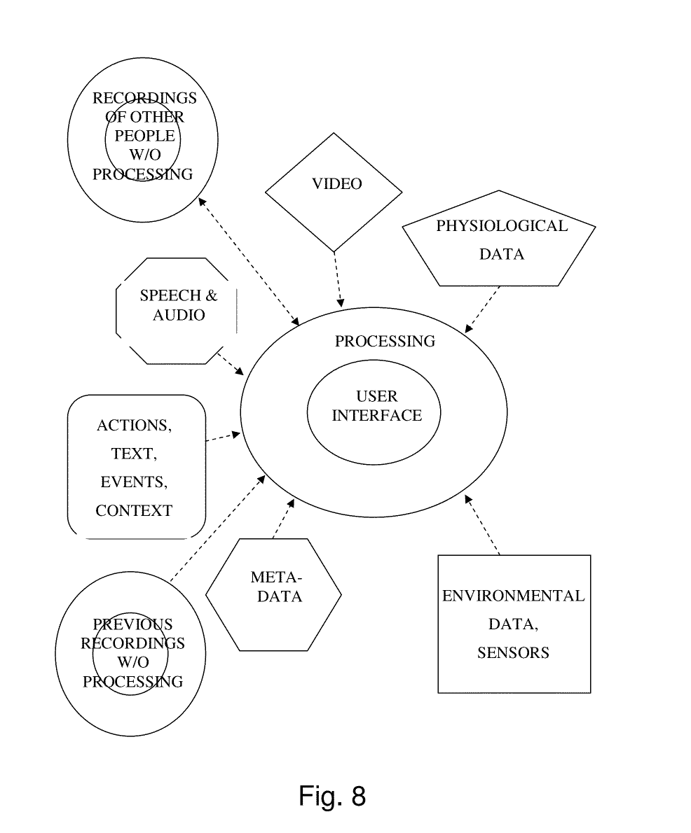

In addition to graphical user interfaces with or without various other indicators, the user interface may be a feature of a computerized system such as smart home, car, robots, hospital, mall, a game, and the like, in which the user interface may consist also of environmental indicators such as: changing the light intensity, colors, music, movements, adapt the presented content of educational and therapeutic software and tools, and more, according to the determined affective content, contextual parameters, and targets of the users, such as increase sales, encourage/discourage certain behaviors, such as diets, avoid driving under influence of tiredness, drink or anger, change the text and/or voice of synthesized speech responses, select a variety of pre-recorded messages, etc. FIG. 8 presents a schematic description of an embodiment of the user interface which conveys and may encompass the analysis of the affective, behavioral and social states of one or more people, and/or consists of a system's response to the affective state of the person or people. The affective state may be processed of various data sources, which may include one or more of the group of previous recordings and/or processing of the same person or people, and/or recordings of other people (with or without prior processing), recordings of various behavioral cues of the person or people, such as verbal and non-verbal speech and vocalizations, and/or postures, movements, gestures, facial expressions, physiological cues, records of actions, text, events, contextual parameters, environmental data and sensor input, meta-data, and the like.

This system of the present invention can help people to better understand and monitor people's behavior, and therefore make decisions that increase their ability to earn and save money, affect our security, safety, and well being, saves time and human power, and it can also be fun.

This system of the present invention can help people to better understand and monitor people's behavior, and therefore make decisions that increase their ability to earn and save money, affect our security, safety, and well being, saves time and human power, and it can also be fun.

Applications of the method/system/software we have described include, but are not limited to, human resources, business, interviews, negotiations, lessons, presentations, speeches and debates, for self-training, assessment, for diagnosis and therapy, for interpretation of the behavior and mood of individuals, as well as of large populations, for call centers—for evaluation of callers, and how to handle them, and for training and assessment of personnel.

All the above description and examples have been given for the purpose of illustration and are not intended to limit the invention in any way. Many different mechanisms, methods of analysis, electronic and logical elements can be employed, all without exceeding the scope of the invention.

1-41. (canceled)

42. A method for the analysis of non-verbal audible expressions in speech, comprising:
providing one or more input means for receiving audible expression from one or more users/participants;
transferring said audible expression into speech signal;
inputting said speech signal into at least one computer system;
processing, at the at least one computer system, said speech signal to determine and output data representing a degree of affective content of said speech signal; and
providing a user interface adapted for allowing the analysis of said output data.

43. A method according to claim 42, wherein said input means is capable of accepting a plurality of input formats, and wherein said user interface is capable of providing output data presenting results of the analysis in a plurality of different output formats.

44. A method according to claim 43, wherein the user interface allows the comparison between speech signals acquired on various occasions, such as pre-recorded signals and real-time signals, and the like.

45. A method according to claim 43, wherein said user interface is configured to provide said graphical indication for a time series of instances of said speech signal, to permit comparison between said time series of instances of said speech signal.

46. A method according to claim 42, wherein the person recording, or the person analyzing, or the analysis system is able to time stamp places of interest, to appear in a visualization or report output.

47. A method according to claim 42, further comprising generating summaries of the analysis either automatically or semi-automatically, with/without details of the analyzed interaction/interactions.

48. A method according to claim 47, wherein the summaries are in a computerized form, with ability of the user to identify a time of interest in the analysis, and hear or see the relevant recorded signal, in particular both from a main application and from one or more of said summaries.

49. A method according to claim 42, wherein the analysis is of the expressions of several users (or other speakers/participants/people defined by the user/s) at the same time.

50. A method according to claim 42, further comprising showing analysis of one or several participant, with various degrees of complexity and detail.

51. A method according to claim 42, wherein said user interface is configured to provide said graphical indication for a plurality of said users/participants simultaneously, to permit comparison between said users/participants.

52. A method according to claim 42, wherein the user is a human or a computerized entity, such as a computer game, or a car, or a robot.

53. A method according to claim 42, wherein said users/participants comprise pupils, or field operators, or pilots, or emergency forces, or drivers, or patients, or clients, or call centre clients, or call centre operators, or analyzers and/or instructors of inter-personal communication.

54. A system or method according to claim 42 configured to combine said affect-representing output data with additional data captured from and relating to an affect state of said user/participant, for determining an affect state of said user in terms of scores for each of a set of affect-related parameters of said speech signal.

55. A method according to claim 54, further comprising allowing presentation and analysis of images, speech signal, various vocal features, analysis of one or of several utterances or sentences, analysis of an entire interaction and of several interactions, various pinpointing and highlighting options in any applicable form such as in graphics, video, sound, speech, text, text-to-speech, electronic formats, numbers, and more.

56. A method according to claim 54, further comprising allowing integrating with one or more modalities or cues, such as video recordings and images of facial expressions, body posture, input comprising verbal content of speech, physiological cues, sensor data, event and context, other electronically available data on the one or several or multiple analyzed user/participant, and interactions.

57. A method according to claim 42, wherein parallel analysis is presented of the various modalities and cues, optionally in multiple formats, including marking of complimenting, enhancing, and/or contradicting analysis results.

58. A method according to claim 42, wherein the analysis is accompanied by additional advice for better decision making, such as graphical and/or vocal advice for training.
